(19) United States
(12) Patent Application Publication
(10) Pub. No.: US 2007/0095296 A1
(43) Pub. Date: May 3, 2007

(54) Apparatus for receiving, storing, and dispensing pet food

(76) Inventor: Monika T. Zuccaro, Marysville, CA (US)

Correspondence Address: JAMES RAY & ASSOCIATES, 2640 PITCAIRN ROAD, MONROEVILLE, PA, 15146, US

(21) Appl. No.: 11/266,579

(22) Filed: Nov. 3, 2005

(51) Int. Cl. A01K 5/01

(52) U.S. Cl. 119/61.5

(57) ABSTRACT

An apparatus for receiving, storing and dispensing pet food. The apparatus comprises a container of a predetermined size, shape, and material for receiving, storing, and dispensing pet food having a first end and a second end. The container has at least one vertical wall. The vertical wall has an interior surface and an exterior surface. The apparatus has a first mechanism for visually determining a quantity of pet food in the container and quantity of pet food to be dispensed. A second mechanism is disposed on at least one of the first end and second end of the container for enclosing and protecting the pet food from spilling and spoilage. The apparatus will permit safe storing and easy dispensing and serving of pet food.

### FIELD OF INVENTION

The present invention relates, in general, to pet food, and more particularly, to an apparatus for receiving, storing, and dispensing pet food.

### BACKGROUND OF THE INVENTION

Prior to the present invention, pet food is typically manufactured and provided in cans for wet pet food, and bags or boxes for moist or dry pet food. Once opened, the bag or box must be tightly resealed to prevent rodent and insect infestation, and spillage. Wet pet food poses additional issues. First, it must either be transferred from the opened can and put into a resealable storage medium for refrigeration, or a sheet of plastic wrap, aluminum foil, or other covering must be applied over the top of the can to prevent spillage and spoilage. This creates an inconvenience for the user, and is not always effective. Also, in order to serve the appropriate amount of pet food, the user must measure the food with a measuring cup or weighing scale.

### SUMMARY OF THE INVENTION

In a first aspect, the present invention provides an apparatus for receiving, storing and dispensing pet food. The apparatus comprises a container of a predetermined size, shape, and material for receiving, storing, and dispensing pet food. The container has a first end and a second end, and at least one vertical wall, said vertical wall further having an interior surface and an exterior surface. A first means is provided for visually determining a quantity of pet food in the container and quantity of pet food to be dispensed. A second means is disposed on at least one of the first end and the second end of the container for enclosing and protecting the pet food in the container from spilling and spoilage. The apparatus will permit safe storing and easy dispensing of pet food.

In a further aspect, the present invention provides an apparatus for receiving, storing and dispensing previously packaged pet food. The apparatus comprises a container of a predetermined size, shape, and material for receiving, storing, and dispensing pet food. The container has a first end and a second end, and at least one vertical wall, said vertical wall further having an interior surface and an exterior surface. A first means is provided for visually determining a quantity of pet food in the container and quantity of pet food to be dispensed. A second means is disposed on at least one of the first end and the second end of the container for enclosing and protecting the pet food in the container from spilling and spoilage. The apparatus will permit safe storing and easy dispensing of pet food.

### OBJECTS OF THE INVENTION

It is therefore the primary objective of the present invention to provide an apparatus for receiving, storing, and dispensing pet food.

Another object of the present invention is to provide a pet food manufacturer with an apparatus for conveniently packaging pet food for the consumer.

Another object of the present invention is to provide an apparatus to the consumer for conveniently receiving, storing, and dispensing previously packaged pet food as supplied by the manufacturer.

In addition to the various objects of the invention that have been described above, various other objects and advantages of the invention will become more readily apparent to those persons skilled in the relevant art from the following more detailed description of the invention, particularly, when such description is taken in conjunction with the attached drawing figures and appended claims.

### BRIEF DESCRIPTION OF THE DRAWINGS

FIG. 1 is a perspective view of the apparatus for receiving, storing, and dispensing pet food; and

FIG. 2 is a front elevation view of the apparatus for receiving, storing and dispensing pet food.

### BRIEF DESCRIPTION OF A PRESENTLY PREFERRED AND VARIOUS ALTERNATIVE EMBODIMENTS OF THE PRESENT INVENTION

Prior to proceeding to a more detailed description of the invention, it should be noted that identical components having identical functions have been designated with identical reference numerals for the sake of clarity.

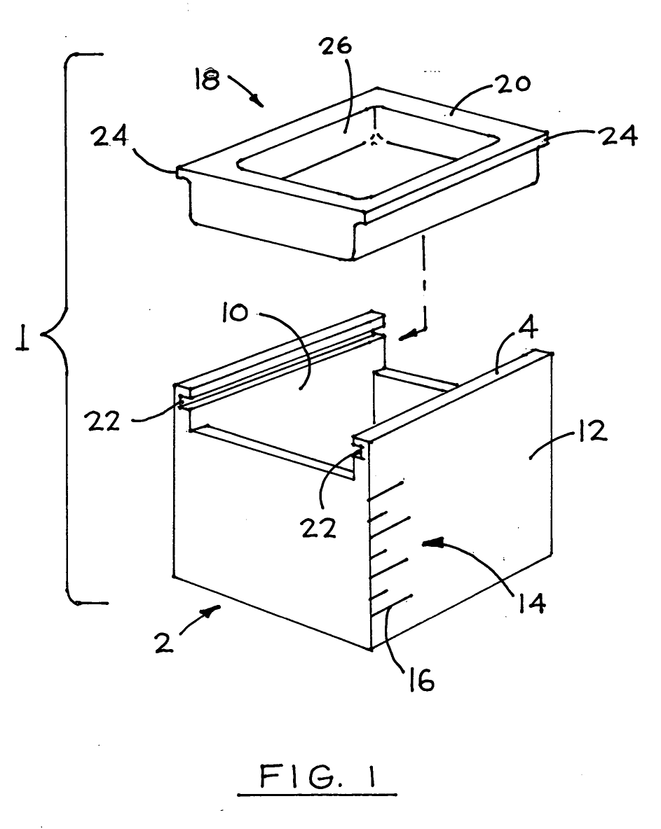

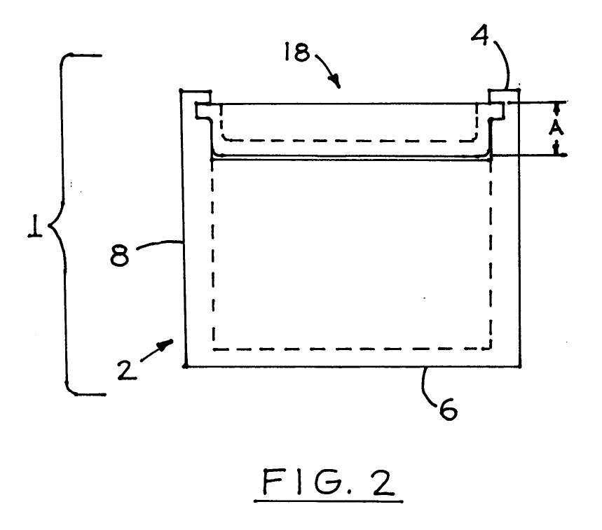

Now refer more particularly to FIGS. 1 and 2 of the drawings. Illustrated therein is an apparatus, generally designated 1, for receiving, storing, and dispensing pet food. The apparatus 1 comprises a container, generally designated 2, of a predetermined size, shape, and material. The container 2 has a first end 4, a second end 6, and at least one vertical wall 8. The vertical wall 8 has an interior surface 10 and an exterior surface 12. The presently preferred size of the container 2 is generally between about 2.5 to 3.5 inches high, 2.5 to 3.5 inches wide, and 2.5 to 3.5 inches deep. Preferably, the shape of the container 2 is at least one of rectangular and cylindrical. The presently preferred shape is rectangular, having four sides of equal dimensions. Preferably, the material of the container 2 is generally transparent, and has a selection of colors from a preselected list of colors. The colors can be used to differentiate the various types of pet food, for example dog food, cat food, and hamster food. Preferably, the material of the container 2 is at least one of glass and plastic. The presently preferred material is plastic. The apparatus 1 has a first means, generally designated 14 for visually determining a quantity of pet food to be dispensed. Preferably, the first means 14 are a plurality of indicia 16 laterally disposed at predetermined increments on the vertical wall 8 of the container 2 for measuring and dispensing the appropriate predetermined quantity of pet food. Preferably, the indicia 16 are disposed on at least one of the interior surface 10 and exterior surface 12 of the container 2. Preferably, the indicia 16 are disposed on the exterior surface 12 of the container 2. The indicia 16 are disposed to measure generally about 0.5 ounce increments. A second means, generally designated 18 is disposed on at least one of the first end 4 and second end 6 for enclosing and protecting the pet food in the container 2. Preferably, the second means 18 is a cover 20 of a predetermined size and shape disposed on the first end 4 of the container 2. The cover 20 in this specification is also meant to include a lid. The preferred shape of the cover 20 is generally square, and the depth A is generally between about 0.5 inch to 1 inch. Preferably, the cover 20 is at least one of hingedly attached and slidably attached to the first end 4 of the container 2. The presently preferred attachment is slidably attached to the first end 4 of the container 2. The interior surface 10 of the container 2 has matching grooves 22 to accept flanges 24 disposed on a perimeter of the cover 18. Preferably, the cover 18 has a hollow receptacle 26 of a predetermined size and depth to be used as a feeding dish. The apparatus 1 will provide the pet food manufacturer a package that will provide the consumer safe storing and easy dispensing and serving of pet food.

Now refer more particularly to FIGS. 1 and 2 of the drawings. Illustrated therein is an apparatus, generally designated 1, for receiving, storing, and dispensing previously packaged pet food. Preferably, the package provided by the manufacturer in at least one of canned, boxed, and bagged. The apparatus 1 comprises a container, generally designated 2, of a predetermined size, shape, and material. The container 2 has a first end 4, a second end 6, and at least one vertical wall 8. The vertical wall 8 has an interior surface 10 and an exterior surface 12. The presently preferred size of the container 2 is generally between about 2.5 to 3.5 inches high, 2.5 to 3.5 inches wide, and 2.5 to 3.5 inches deep. Preferably, the shape of the container 2 is at least one of rectangular and cylindrical. The presently preferred shape is rectangular, having four sides of equal dimensions. Preferably, the material of the container 2 is generally transparent, and has a selection of colors from a preselected list of colors. The colors can be used to differentiate the various types of pet food, for example dog food, cat food, and hamster food. Preferably, the material of the container 2 is at least one of glass and plastic. The presently preferred material is plastic. The apparatus 1 has a first means, generally designated 14 for visually determining a quantity of pet food to be dispensed. Preferably, the first means 14 are a plurality of indicia 16 laterally disposed at predetermined increments on the vertical wall 8 of the container 2 for measuring and dispensing the appropriate predetermined quantity of pet food. Preferably, the indicia 16 are disposed on at least one of the interior surface 10 and exterior surface 12 of the container 2. Preferably, the indicia 16 are disposed on the exterior surface 12 of the container 2. The indicia 16 are disposed to measure generally about 0.5 ounce increments. A second means, generally designated 18 is disposed on at least one of the first end 4 and second end 6 for enclosing and protecting the pet food in the container 2. Preferably, the second means 18 is a cover 20 of a predetermined size and shape disposed on the first end 4 of the container 2. The preferred shape of the cover 20 is generally square, and the depth A is generally between about 0.5 inch to 1 inch. Preferably, the cover 20 is at least one of hingedly attached and slidably attached to the first end 4 of the container 2. The presently preferred attachment is slidably attached to the first end 4 of the container 2. The interior surface 10 of the container 2 has matching grooves 22 to accept flanges 24 disposed on a perimeter of the cover 18. Preferably, the cover 18 has a hollow receptacle 26 of a predetermined size and depth to be used as a feeding dish. The apparatus 1 will permit safe storing and easy dispensing and serving of previously packaged pet food as purchased by the consumer.

Although the invention has been shown in connection with a certain specific embodiment, it will be readily apparent to those skilled in the art that various changes in form and arrangement of parts and method may be made to suit requirements without departing from the spirit and scope of the invention.

I claim:

1. An apparatus for receiving, storing and dispensing pet food, said apparatus comprising:
a) a container of a predetermined size, shape, and material for receiving, storing, and dispensing such pet food having a first end and a second end, said container further having at least one vertical wall, said vertical wall further having an interior surface and an exterior surface;
b) a first means for visually determining a quantity of such pet food in said container and such quantity of such pet food to be dispensed; and
c) a second means disposed on at least one of said first end and said second end of said container for enclosing and protecting such pet food in said container from spilling and spoilage, whereby said apparatus will provide the consumer safe storing and easy dispensing and serving of such pet food.

2. The apparatus according to claim 1 wherein said shape of said container is at least one of rectangular and cylindrical.

3. The apparatus according to claim 2 wherein said shape of said container is generally rectangular, having four vertical sides of equal dimensions.

4. The apparatus according to claim 1 wherein said size of said container is generally about 2.5 to 3.5 inches high, 2.5 to 3.5 inches wide, and 2.5 to 3.5 inches deep.

5. The apparatus according to claim 1 wherein said material of said container is generally transparent and having a selection of colors from a preselected list of colors.

6. The apparatus according to claim 1 wherein said material is at least one of glass and plastic.

7. The apparatus according to claim 6 wherein said material is plastic.

8. The apparatus according to claim 1 wherein said first means are indicia laterally disposed at predetermined increments on said vertical wall of said container for measuring and dispensing the appropriate predetermined quantity of such pet food.

9. The apparatus according to claim 8 wherein said predetermined increments are disposed to measure generally about 0.5 ounces.

10. The apparatus according to claim 8 wherein said indicia are disposed on at least one of said interior surface and said exterior surface of said container.

11. The apparatus according to claim 10 wherein said indicia are disposed on said exterior surface of said container.

12. The apparatus according to claim 1 wherein said second means is a cover of a predetermined size and shape disposed on said first end of said container.

13. The apparatus according to claim 12 wherein said cover is generally square and having a depth generally between about 0.5 inch to 1 inch.

14. The apparatus according to claim 12 wherein said cover is at least one of hingedly attached and slidably attached to said first end of said container.

15. The apparatus according to claim 14 wherein said cover is slidably attached to said first end of container, said interior surface of said container further has matching grooves to accept flanges disposed on a perimeter of said cover.

16. The apparatus according to claim 14 wherein said cover has a hollow receptacle of a predetermined size and depth to be used as a feeding dish.

17. An apparatus for receiving, storing and dispensing previously packaged pet food, said apparatus comprising:
a) a container of a predetermined size, shape, and material for receiving, storing, and dispensing such pet food having a first end and a second end, said container further having at least one vertical wall, said vertical wall further having an interior surface and an exterior surface;
b) a first means for visually determining a quantity of such pet food in said container and such quantity of such pet food to be dispensed; and
c) a second means disposed on at least one of said first end and said second end of said container for enclosing and protecting such pet food in said container from spilling and spoilage, whereby said apparatus will permit safe storing and easy dispensing of such pet food.

18. The apparatus according to claim 17 wherein such previously packaged pet food is at least one of canned, boxed, and bagged.

19. The apparatus according to claim 17 wherein said shape of container is generally rectangular, having four vertical sides of equal dimensions.

20. The apparatus according to claim 17 wherein said first means are indicia laterally disposed at predetermined increments on said vertical wall of said container for measuring and dispensing the appropriate predetermined quantity of such pet food.

21. The apparatus according to claim 17 wherein said second means is a cover of a predetermined size and shape disposed on said first end of said container.
